(19) United States
(12) Patent Application Publication
(10) Pub. No.: US 2020/0262326 A1
(43) Pub. Date: Aug. 20, 2020

(54) VEHICULAR BOARDING ASSISTANCE DEVICE, CONTROL UNIT FOR VEHICULAR BOARDING ASSISTANCE DEVICE, AND VEHICLE BOARDING ASSISTANCE METHOD

(71) Applicant: AISIN SEIKI KABUSHIKI KAISHA, Kariya-shi (JP)

(72) Inventors: Koichiro HONDA, Kariya-shi (JP); Hiroshi Kajino, Kariya-shi (JP); Norio Fukui, Kariya-shi (JP)

(73) Assignee: AISIN SEIKI KABUSHIKI KAISHA, Kariya-shi (JP)

(21) Appl. No.: 16/776,576

(22) Filed: Jan. 30, 2020

(30) Foreign Application Priority Data
Feb. 14, 2019 (JP) 2019-024393

(51) Int. Cl. B60P 1/43; B60R 3/02; B60N 2/01; B60P 1/26

(52) U.S. Cl. CPC B60P 1/431; B60P 1/26; B60N 2/01; B60R 3/02

(57) ABSTRACT

A vehicular boarding assistance device includes: a slope main body provided in a body of a vehicle so as to project and retract and configured to form a slope by being bridged between the body and a ground surface in a state of projecting from the body; a slope drive source configured to drive the slope main body so as to project and retract; a seat drive source configured to drive at least one of a plurality of seats installed on a floor of the vehicle; and a control unit configured to drive and control the slope drive source such that the slope main body projects and drive and control the seat drive source such that an occupying region of a boarding assistance target moving on the slope and moving to the floor is secured on the floor.

### CROSS REFERENCE TO RELATED APPLICATIONS

This application is based on and claims priority under 35 U.S.C. § 119 to Japanese Patent Application 2019-024393, filed on Feb. 14, 2019, the entire contents of which are incorporated herein by reference.

### TECHNICAL FIELD

This disclosure relates to a vehicular boarding assistance device capable of forming a slope for boarding assistance, a control unit for a vehicular boarding assistance device, and a vehicle boarding assistance method.

### BACKGROUND DISCUSSION

In the related art, a vehicular boarding assistance device described in, for example, JP 2003-285691A (Reference 1) is known as such a vehicular boarding assistance device. This vehicular boarding assistance device is provided with a slope main body or the like provided so as to be capable of moving into and out of an underfloor storage chamber of the body of a vehicle and a slope for boarding assistance is formed by the slope main body or the like projecting from the inside of the underfloor storage chamber and being bridged between the underfloor storage chamber and a ground surface. As a result, it is asserted that a wheelchair moves on the slope toward the floor and the boarding of the wheelchair is smoothly performed.

In Reference 1, the slope main body or the like needs to be manually moved into and out of the underfloor storage chamber during the slope formation and the manual movement is troublesome. In addition, a plurality of seats for seating are mounted on the floor of the vehicle in many cases. Accordingly, the seats need to be removed or moved in advance, which is troublesome, for the occupying region of a boarding assistance target moving on the slope, such as a wheelchair, to be secured on the floor.

Thus, a need exists for a vehicular boarding assistance device, a control unit for a vehicular boarding assistance device, and a vehicle boarding assistance method which are not susceptible to the drawback mentioned above.

### SUMMARY

A vehicular boarding assistance device according to an aspect of this disclosure includes a slope main body provided in a body of a vehicle so as to project and retract and configured to form a slope by being bridged between the body and a ground surface in a state of projecting from the body, a slope drive source configured to drive the slope main body so as to project and retract, a seat drive source configured to drive at least one of a plurality of seats installed on a floor of the vehicle, and a control unit configured to drive and control the slope drive source such that the slope main body projects and drive and control the seat drive source such that an occupying region of a boarding assistance target moving on the slope and moving to the floor is secured on the floor.

A control unit for a vehicular boarding assistance device according to another aspect of this disclosure is a control unit for a vehicular boarding assistance device for controlling a slope drive source configured to drive a slope main body to project and retract, the slope main body being provided in a body of a vehicle so as to project and retract and forming a slope by being bridged between the body and a ground surface in a state of projecting from the body, and a seat drive source configured to drive at least one of a plurality of seats installed on a floor of the vehicle. The control unit drives and controls the slope drive source such that the slope main body projects and drives and controls the seat drive source such that an occupying region of a boarding assistance target moving on the slope and moving to the floor is secured on the floor.

A vehicle boarding assistance method according to another aspect of this disclosure includes a determination step of determining the presence or absence of a boarding assistance target, a boarding assistance step of causing a slope main body to project from a vehicle in a case where it is determined that the boarding assistance target is present in the determination step, and a movement step of moving within the vehicle an obstacle disposed in the vehicle so as to secure an occupying region of the boarding assistance target in the vehicle in a case where it is determined that the boarding assistance target is present in the determination step.

### BRIEF DESCRIPTION OF THE DRAWINGS

The foregoing and additional features and characteristics of this disclosure will become more apparent from the following detailed description considered with the reference to the accompanying drawings, wherein:

FIGS. 1A to 1C are perspective views illustrating a vehicle to which an embodiment of a vehicular boarding assistance device, a control unit for a vehicular boarding assistance device, and a vehicle boarding assistance method is applied, in which FIG. 1A illustrates the vehicle in an initial state of stopping in front of a user, FIG. 1B illustrates the vehicle in a state where a slope main body projects, and FIG. 1C illustrates the vehicle in a state where a door is open with a slope formed;

FIG. 2 is a perspective view illustrating a plurality of seats to which the vehicular boarding assistance device, the control unit for a vehicular boarding assistance device, and the vehicle boarding assistance method of the embodiment are applied;

FIG. 3 is a block diagram illustrating the electrical configuration of the vehicular boarding assistance device, the control unit for a vehicular boarding assistance device, and the vehicle boarding assistance method of the embodiment;

FIGS. 4A to 4C are plan views schematically illustrating a drive control mode of the plurality of seats in a case where a boarding assistance target is a wheelchair with regard to the vehicular boarding assistance device, the control unit for a vehicular boarding assistance device, and the vehicle boarding assistance method of the embodiment;

FIGS. 5A to 5D are plan views schematically illustrating a drive control mode of the plurality of seats in a case where the boarding assistance target is a stroller with regard to the vehicular boarding assistance device, the control unit for a vehicular boarding assistance device, and the vehicle boarding assistance method of the embodiment;

FIG. 6 is a flowchart illustrating a drive control mode in a case where the boarding assistance target is a wheelchair with regard to the vehicular boarding assistance device, the control unit for a vehicular boarding assistance device, and the vehicle boarding assistance method of the embodiment;

FIG. 7 is a flowchart illustrating a drive control mode in a case where the boarding assistance target is a stroller with regard to the vehicular boarding assistance device, the control unit for a vehicular boarding assistance device, and the vehicle boarding assistance method of the embodiment;

FIGS. 8A to 8C are side views illustrating the structure and action of a seat to which a variation of the vehicular boarding assistance device, the control unit for a vehicular boarding assistance device, and the vehicle boarding assistance method is applied; and

FIGS. 9A and 9B are side views illustrating the structure and action of a seat to which another variation of the vehicular boarding assistance device, the control unit for a vehicular boarding assistance device, and the vehicle boarding assistance method is applied.

### DETAILED DESCRIPTION

Hereinafter, an embodiment of a vehicular boarding assistance device, a control unit for a vehicular boarding assistance device, and a vehicle boarding assistance method will be described.

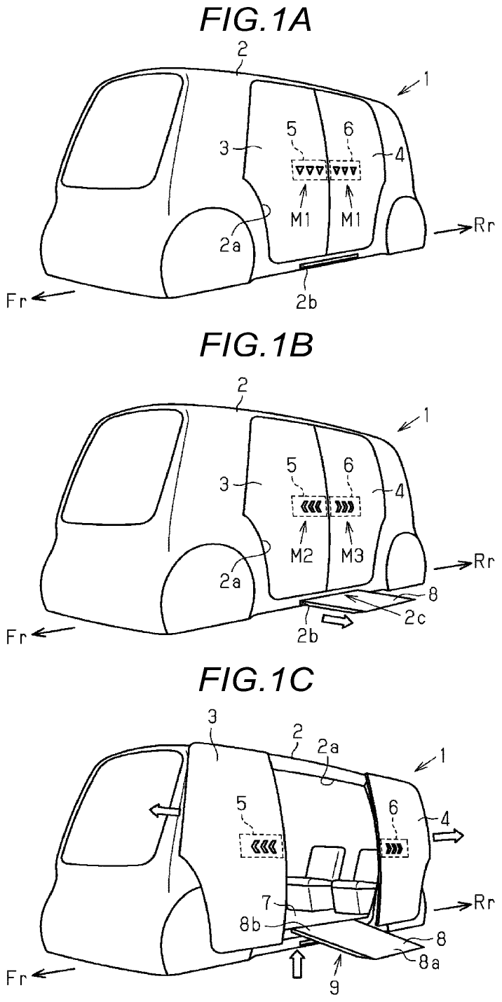

As illustrated in FIGS. 1A to 1C, an opening 2a is formed in a side portion of a body 2 of a vehicle 1 such as an automobile. A front slide door 3 and a rear slide door 4 are mounted in the side portion of the body 2. The front slide door 3 and the rear slide door 4 open the opening 2a by moving away from each other in a front-rear direction and close the opening 2a by moving toward each other in the front-rear direction.

A front display 5 and a rear display 6 are mounted on the front slide door 3 and the rear slide door 4, respectively. The front display 5 and the rear display 6 are capable of displaying notification information including a character or a symbol visible from the outside of the vehicle 1. The front display 5 and the rear display 6 include, for example, a liquid crystal or LED display panel.

A substantially quadrangular slope entrance/exit 2b extending in the front-rear direction and an underfloor storage chamber 2c are formed in the lower portion of the side portion of the body 2 that is positioned below a floor 7 of the vehicle 1. The underfloor storage chamber 2c extends from the slope entrance/exit 2b toward the inside of the vehicle 1. In addition, a substantially quadrangular plate-shaped slope main body 8 is provided in the lower portion of the side portion of the body 2 so as to be capable of moving into and out of the underfloor storage chamber 2c. The slope main body 8 is stored in the underfloor storage chamber 2c by being retracted from the slope entrance/exit 2b to the inside of the vehicle 1 and forms a slope 9 by being bridged between the slope entrance/exit 2b and a ground surface in a state of projecting from the slope entrance/exit 2b to the outside of the vehicle 1. In a state where the slope main body 8 forms the slope 9, a distal end 8a on the side opposite to the body 2 in the projecting and retracting direction of the slope 9 is in contact with the ground surface and a distal end 8b on the body 2 side is raised to a position matching the height of the floor 7. As a result, the slope 9 is formed such that there is no step between the ground surface and the distal end 8a and there is no step between the distal end 8b and the floor 7.

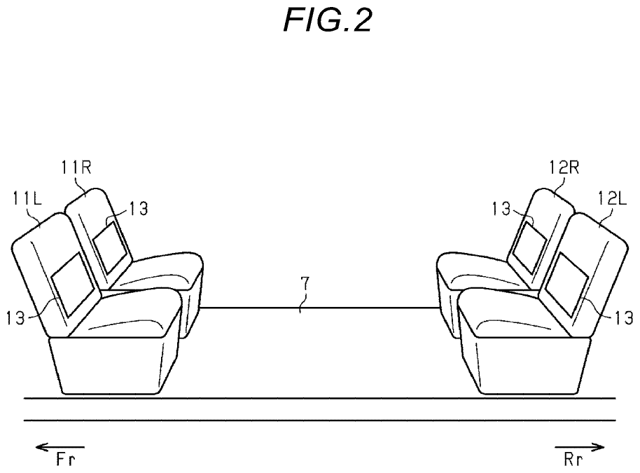

As illustrated in FIG. 2, a pair of front seats 11R and 11L arranged in the width direction of the vehicle and a pair of rear seats 12R and 12L arranged in the width direction of the vehicle to a rear Rr of the front seats 11R and 11L are installed on the floor 7. The front seat 11R and the rear seat 12R are disposed so as to face each other in the front-rear direction and be spaced apart from each other in the front-rear direction. Likewise, the front seat 11L and the rear seat 12L are disposed so as to face each other in the front-rear direction and be spaced apart from each other in the front-rear direction.

A slide mechanism (not illustrated) allowing a movement in the front-rear direction on the floor 7 is installed for each of the front seats 11R and 11L and the rear seats 12R and 12L. Accordingly, the region on the floor 7 that is defined by the front seats 11R and 11L and the rear seats 12R and 12L changes by at least one of the front seats 11R and 11L and the rear seats 12R and 12L moving in the front-rear direction.

In addition, a storage-type child restraint device 13 is installed on each of the front seats 11R and 11L and the rear seats 12R and 12L. The child restraint device 13 fixes a child such as a baby and an infant in a deployed state.

Next, the electrical configuration of the present embodiment will be described.

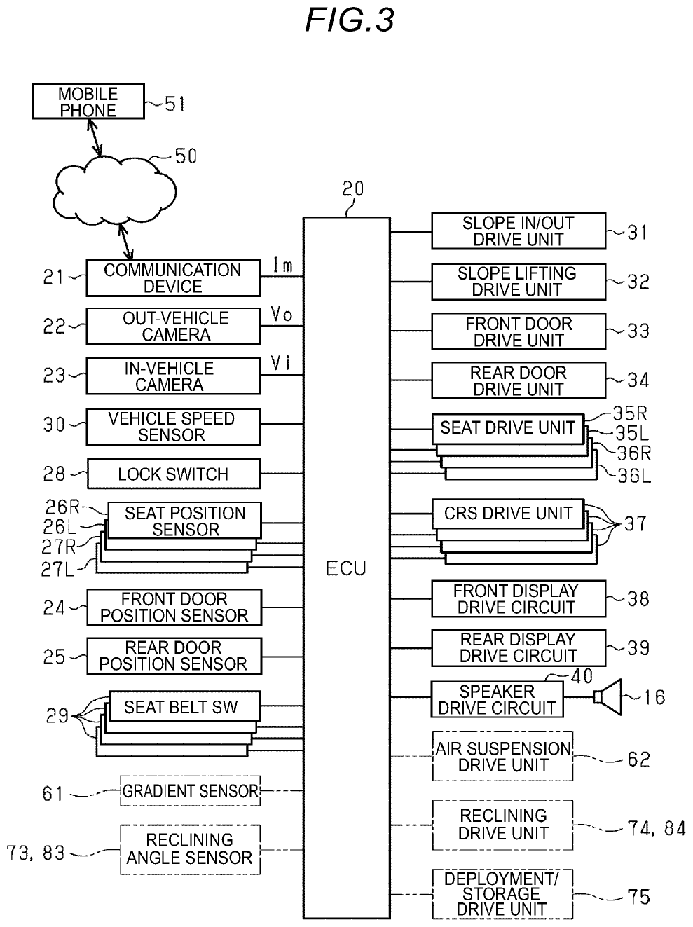

As illustrated in FIG. 3, the vehicular boarding assistance device is provided with an ECU 20 as a control unit including, for example, an MCU (microcomputer). A communication device 21 supporting a wireless communication standard such as long term evolution (LTE) is connected to the ECU 20. The communication device 21 communicates with a mobile phone 51 such as a smartphone carried by a user via a wireless communication network 50. The ECU 20 inputs an information signal Im representing various types of information received from the mobile phone 51 by the communication device 21. The timing of the input of the information signal Im using the wireless communication network 50 may be a timing at which the user carrying the mobile phone 51 is present outside the vehicle 1 or any timing at which the user is away from the vehicle 1.

Examples of the information include whether or not a person carrying the mobile phone 51 is a regular user. “Regular user” refers to an owner of the vehicle 1 or the like when the vehicle 1 is a privately owned car. In addition, “regular user” refers to a person reserving the vehicle 1 or the like when the vehicle 1 is a taxi or a shared car. Alternatively, the examples include the state of use of the vehicle 1 registered in advance from the regular user's mobile phone 51 such as the number of passengers, the number of wheelchairs, the number of strollers, and the number of luggage such as large suitcases. In a case where the vehicle 1 is a self-driving car used as a taxi or a shared car, the information may be when or where the vehicle 1 is scheduled to be used.

An out-vehicle camera 22 installed at an appropriate location outside the vehicle 1 is connected to the ECU 20. The ECU 20 detects the state of the outside of the vehicle 1 by recognizing an image based on a video signal Vo input from the out-vehicle camera 22. The state of the outside of the vehicle 1 is, for example, whether or not a person present outside the vehicle 1 is the regular user. Alternatively, the state is the number of persons present outside the vehicle 1, the number of wheelchairs, the number of strollers, or the number of luggage such as large suitcases.

The ECU 20 determines the presence or absence of a boarding assistance target as a determination step based on, for example, the wheelchair detected or the like as described above.

An in-vehicle camera 23 as a detection section installed at an appropriate location inside the vehicle 1 is connected to the ECU 20. The ECU 20 detects the state of the inside of the vehicle 1 by recognizing an image based on a video signal Vi input from the in-vehicle camera 23. The state of the inside of the vehicle 1 is, for example, whether or not a person present inside the vehicle 1 is the regular user. Alternatively, the state is the state of holding of a seat or a wheelchair in which a person present inside the vehicle 1 intends to sit, the state of fixing of a child who has moved from a stroller to the child restraint device 13, or the location of disposition of luggage such as a large suitcase.

An appropriate front door position sensor 24 and an appropriate rear door position sensor 25 are connected to the ECU 20. The front door position sensor 24 and the rear door position sensor 25 detect the opening/closing positions of the front slide door 3 and the rear slide door 4, respectively. The ECU 20 detects the opening/closing positions of the front slide door 3 and the rear slide door 4 based on the detection results of the front door position sensor 24 and the rear door position sensor 25, respectively.

Appropriate front seat position sensors 26R and 26L and appropriate rear seat position sensors 27R and 27L are connected to the ECU 20. The front seat position sensors 26R and 26L detect the front-rear positions of the front seats 11R and 11L, respectively. The rear seat position sensors 27R and 27L detect the front-rear positions of the rear seats 12R and 12L, respectively. The ECU 20 detects the front-rear positions of the front seats 11R and 11L based on the detection results of the front seat position sensors 26R and 26L, respectively. The ECU 20 detects the front-rear positions of the rear seats 12R and 12L based on the detection results of the rear seat position sensors 27R and 27L, respectively.

An appropriate lock switch 28 is connected to the ECU 20 and the lock switch 28 switches logic when a lock device (not illustrated) holds a wheelchair on the floor 7. The ECU 20 determines, based on the detection result of the lock switch 28, whether or not the wheelchair remains held.

An appropriate seat belt switch 29 is connected to the ECU 20 and the seat belt switch 29 switches logic when seat belts (not illustrated) respectively provided for the front seats 11R and 11L and the rear seats 12R and 12L are worn. The ECU 20 determines, particularly based on the detection result of the seat belt switch 29 of a seat where the child restraint device 13 is in a state of use, whether or not a child using the child restraint device 13 remains fixed.

An appropriate vehicle speed sensor 30 detecting the traveling speed of the vehicle 1 is connected to the ECU 20. The ECU 20 detects, based on the detection result of the vehicle speed sensor 30, the traveling state of the vehicle 1 such as the stopped state of the vehicle 1.

A slope in/out drive unit 31 installed in, for example, the lower portion of the body 2 is connected to the ECU 20. The slope in/out drive unit 31 mainly includes an electric drive source such as an electric motor and drives the slope main body 8 in and out by being mechanically linked to the slope main body 8 via an appropriate slope in/out drive mechanism.

A slope lifting drive unit 32 installed in, for example, the lower portion of the body 2 is connected to the ECU 20. The slope lifting drive unit 32 mainly includes an electric drive source such as an electric motor and drives the distal end 8b of the slope main body 8 to be lifted by being mechanically linked to the slope main body 8 via an appropriate slope lifting drive mechanism. The slope lifting drive unit 32 and the slope in/out drive unit 31 constitute a slope drive source.

A front door drive unit 33 and a rear door drive unit 34 are connected to the ECU 20. The front door drive unit 33 and the rear door drive unit 34 are, for example, respectively installed in the front slide door 3 and the rear slide door 4. The front door drive unit 33 and the rear door drive unit 34 mainly include an electric drive source such as an electric motor. The front door drive unit 33 and the rear door drive unit 34 drive the front slide door 3 and the rear slide door 4 to be opened/closed by being mechanically linked to the body 2 via an appropriate front door drive mechanism and an appropriate rear door drive mechanism, respectively.

Front seat drive units 35R and 35L are connected to the ECU 20. The front seat drive units 35R and 35L are installed in the front seats 11R and 11L, respectively. The front seat drive units 35R and 35L mainly include an electric drive source such as an electric motor. The front seat drive units 35R and 35L drive the front seats 11R and 11L to move in the front-rear direction by being mechanically linked to an appropriate seat slide mechanism, respectively.

Rear seat drive units 36R and 36L are connected to the ECU 20. The rear seat drive units 36R and 36L are installed in the rear seats 12R and 12L, respectively. The rear seat drive units 36R and 36L mainly include an electric drive source such as an electric motor. The rear seat drive units 36R and 36L drive the rear seats 12R and 12L to move in the front-rear direction by being mechanically linked to an appropriate seat slide mechanism, respectively.

The front seat drive units 35R and 35L and the rear seat drive units 36R and 36L constitute a seat drive source.

A child restraint device drive unit 37 is connected to the ECU 20. The child restraint device drive unit 37 is installed in each of the front seats 11R and 11L and the rear seats 12R and 12L. The child restraint device drive unit 37 mainly includes, for example, an electromagnetic solenoid valve switching between the intake and exhaust of the airbag that is incorporated in the child restraint device 13 and drives the child restraint device 13 to be deployed and stored by expanding and contracting the airbag, respectively. Accordingly, the ECU 20 recognizes, without aid, a seat where the child restraint device 13 is in a state of use.

A front display drive circuit 38 and a rear display drive circuit 39 are connected to the ECU 20. The front display drive circuit 38 and the rear display drive circuit 39 are connected to the front display 5 and the rear display 6, respectively. The ECU 20 performs drive control on the display of the front display 5 and the display of the rear display 6 via the front display drive circuit 38 and the rear display drive circuit 39, respectively.

A speaker drive circuit 40 is connected to the ECU 20. The speaker drive circuit 40 is connected to a speaker 16 installed at an appropriate location of the vehicle 1. The ECU 20 performs drive control on the voice of the speaker 16 via the speaker drive circuit 40.

Next, the action of the vehicle 1 that is realized by the various types of drive control performed by the ECU 20 will be described. It is assumed that a person is present outside the vehicle 1 that is stationary, the person is the regular user, and the person being the regular user has been detected as described above. In addition, it is assumed that at least one of luggage such as a wheelchair, a stroller, and a large suitcase is present outside the vehicle 1 and the presence has been detected as described above. In other words, a case is assumed where it has been determined in the determination step that the boarding assistance target is present.

As illustrated in FIG. 1A, at this time, a plurality of inverted triangular marks M1 arranged in the front-rear direction are displayed on the front display 5 and the rear display 6 respectively mounted on the front slide door 3 and the rear slide door 4 that are in a fully closed state. This is to alert the user present outside the vehicle 1 and the surroundings of the user to the projecting operation of the slope main body 8. Characters such as “caution below” may be displayed instead of the mark M1.

Subsequently, a plurality of “<” marks M2 and a plurality of “>” marks M3 arranged in the front-rear direction on the front slide door 3 and the rear slide door 4 are respectively displayed as illustrated in FIG. 1B. This is to alert the user present outside the vehicle 1 and the surroundings of the user to the opening operation of the front slide door 3 and the rear slide door 4. Characters such as “open” may be displayed instead of the marks M2 and M3. At this time, the slope main body 8 projects from the slope entrance/exit 2b as a boarding assistance step.

Subsequently, the front slide door 3 and the rear slide door 4 are opened and the distal end 8b of the slope main body 8 forms the slope 9 by being raised as illustrated in FIG. 1C.

In conjunction, the front-rear positions of the front seats 11R and 11L and the rear seats 12R and 12L are adjusted as a movement step.

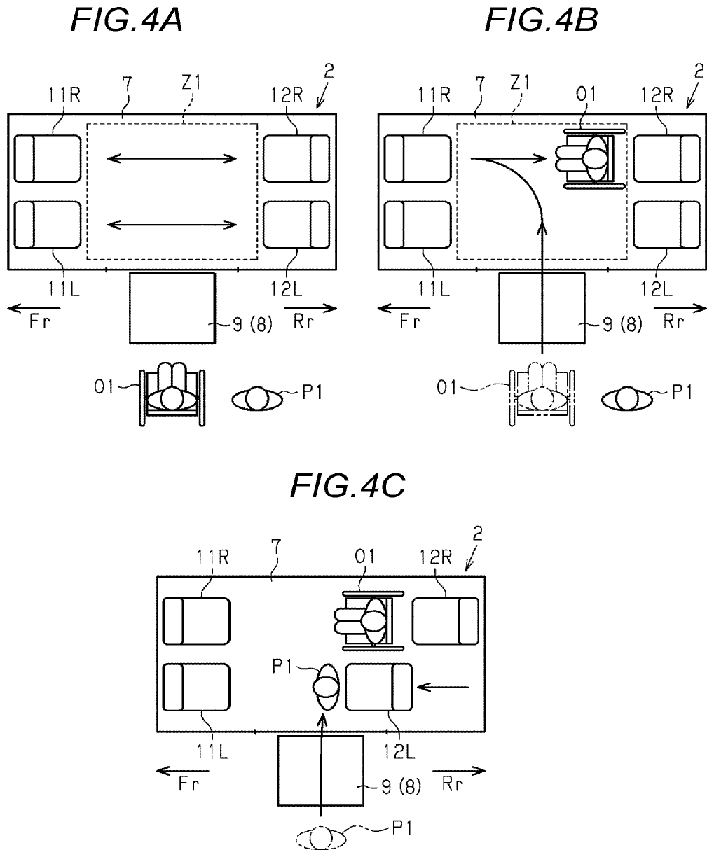

In other words, as illustrated in FIG. 4A, it is assumed that the presence of a wheelchair O1 outside the vehicle 1 has been detected and the wheelchair O1 is a boarding assistance target moving on the slope 9 and moving to the floor 7. The information of the information signal Im received from the mobile phone 51 may be used for the detection of the wheelchair O1, the image recognition result of the video signal Vo may be used for the detection of the wheelchair O1, or the information and the result may be used in combination for the detection of the wheelchair O1. At this time, the front seats 11R and 11L and the rear seats 12R and 12L move away from each other in the front-rear direction until reaching the foremost and rearmost positions of the movable range, respectively. This is to secure an occupying region Z1 of the wheelchair O1 on the floor 7 by increasing the front-rear-direction separation distance between the front seats 11R and 11L and the rear seats 12R and 12L.

“Occupying region Z1” refers to a region including a disposition region that can be used for the wheelchair O1 to be disposed and a movement region that can be used for a movement of the wheelchair O1 for reaching the disposition region.

As a result, the wheelchair O1 in which a person with walking difficulties sits is capable of smoothly moving to a regular position on the floor 7 using the occupying region Z1 as illustrated in FIG. 4B. Here, the regular position on the floor 7 is a position where the wheelchair O1 faces a front Fr to the front Fr of the rear seat 12R.

Subsequently, when the wheelchair O1 is held at the regular position and the seat on which a companion P1 intends to sit is detected, the seat is moved to an optimum position as illustrated in FIG. 4C. Illustrated here is a case where the rear seat 12L is the seat on which the companion P1 intends to sit and the optimum position is the front-rear position that is next to the wheelchair O1. It is a matter of course that the occupying region Z1 is changed as a result. In other words, the original seat arrangement for securing the occupying region Z1 is changed to a seat arrangement for optimization during movement. The holding state of the wheelchair O1 is detected by the lock switch 28 described above. In addition, the seat on which the companion P1 intends to sit is detected by, for example, image recognition being performed on the video signal Vi of the in-vehicle camera 23.

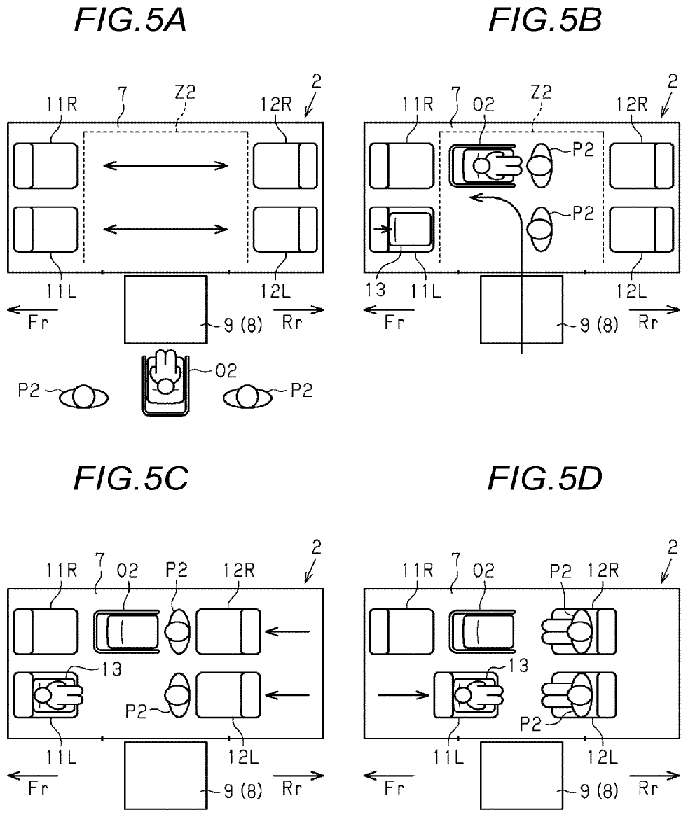

It is assumed as illustrated in FIG. 5A that the presence of a stroller O2 outside the vehicle 1 has been detected and the stroller O2 is a boarding assistance target moving on the slope 9 and moving to the floor 7. The information of the information signal Im received from the mobile phone 51 may be used for the detection of the stroller O2, the image recognition result of the video signal Vo may be used for the detection of the stroller O2, or the information and the result may be used in combination for the detection of the stroller O2. Also at this time, the front seats 11R and 11L and the rear seats 12R and 12L move away from each other in the front-rear direction until reaching the foremost and rearmost positions of the movable range, respectively. This is to secure an occupying region Z2 of the stroller O2 on the floor 7 by increasing the front-rear-direction separation distance between the front seats 11R and 11L and the rear seats 12R and 12L.

“Occupying region Z2” refers to a region including a disposition region that can be used for the stroller O2 to be disposed and a movement region that can be used for a movement of the stroller O2 for reaching the disposition region.

As a result, the stroller O2 carrying a child is capable of smoothly moving to an appropriate position on the floor 7 using the occupying region Z2 and together with a companion P2 as illustrated in FIG. 58. Here, the appropriate position on the floor 7 is a position to the rear Rr of the front seat 11R.

Subsequently, when a seat where the companion P2 intends to fix the child in the stroller O2 is detected, the child restraint device 13 of the seat is deployed. Illustrated here is a case where the front seat 11L is the seat where the companion P2 intends to fix the child. The seat where the companion P1 intends to fix the child is detected by, for example, image recognition being performed on the video signal Vi of the in-vehicle camera 23.

Subsequently, when the child using the child restraint device 13 is fixed and the seat on which the companion P2 intends to sit is detected, the seat is moved to an optimum position as illustrated in FIG. 5C. Illustrated here is a case where the rear seats 12R and 12L are the seats as companion seats on which the companion P2 intends to sit and the optimum positions of the seats are the front-rear positions that are next to each other and closest to the child restraint device 13. The fixed state of the child using the child restraint device 13 is detected by the seat belt switch 29 disposed on the front seat 11L. In addition, the seat on which the companion P2 intends to sit is detected by, for example, image recognition being performed on the video signal Vi of the in-vehicle camera 23.

Subsequently, the front seat 11L as a child fixing seat on which the child restraint device 13 is deployed reaches the optimum position as illustrated in FIG. 5D. Here, the optimum position of the front seat 11L is the front-rear position that is closest to the rear seats 12R and 12L.

It is a matter of course that the occupying region Z2 is changed as a result. In other words, the original seat arrangement for securing the occupying region Z2 is changed to a seat arrangement for optimization during movement.

Next, the mode of the drive control by the ECU 20 at a time when the wheelchair O1 is present outside the vehicle 1 will be collectively described. This processing is activated when the regular user is present outside the vehicle 1 that is stationary.

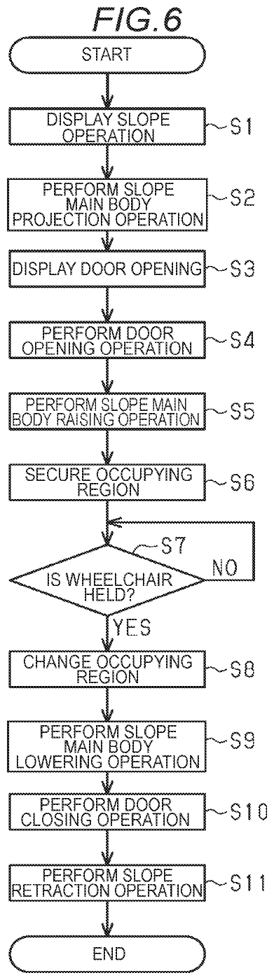

As illustrated in FIG. 6, when the processing proceeds to this routine, the front display drive circuit 38 and the rear display drive circuit 39 are driven and controlled in Step S1 such that the mark M1, which is to alert the user and the surroundings of the user to the projecting operation of the slope main body 8, is displayed on the front display 5 and the rear display 6. Then, in Step S2, the slope in/out drive unit 31 is driven and controlled such that the slope main body 8 projects. In addition, in Step S3, the front display drive circuit 38 and the rear display drive circuit 39 are driven and controlled such that the marks M2 and M3, which are to alert the user and the surroundings of the user to the opening operation of the front slide door 3 and the rear slide door 4, are respectively displayed on the front display 5 and the rear display 6.

Subsequently, in Step S4, the front door drive unit 33 and the rear door drive unit 34 are respectively driven and controlled such that the front slide door 3 and the rear slide door 4 are opened. In addition, in Step S5, the slope lifting drive unit 32 is driven and controlled such that the distal end 8b of the slope main body 8 is raised.

Subsequently, in Step S6, the front seat drive units 35R and 35L and the rear seat drive units 36R and 36L are driven and controlled such that the occupying region Z1 of the wheelchair O1 is secured on the floor 7. Then, in Step S7, it is determined, based on the detection result of the lock switch 28, whether or not the wheelchair O1 that has moved on the slope 9 and moved to the floor 7 has been held. Here, after waiting for the wheelchair O1 to be held, the front seat drive units 35R and 35L and the rear seat drive units 36R and 36L are driven and controlled such that the occupying region Z1 is changed in Step S8.

Then, in Step S9, the slope lifting drive unit 32 is driven and controlled such that the distal end 8b of the slope main body 8 is lowered. In addition, in Step S10, the front door drive unit 33 and the rear door drive unit 34 are respectively driven and controlled such that the front slide door 3 and the rear slide door 4 are closed. Further, in Step S11, the slope in/out drive unit 31 is driven and controlled such that the slope main body 8 is retracted. Then, the processing is ended.

Next, the mode of the drive control by the ECU 20 at a time when the stroller O2 is present outside the vehicle 1 will be collectively described. This processing is activated when the regular user is present outside the vehicle 1 that is stationary.

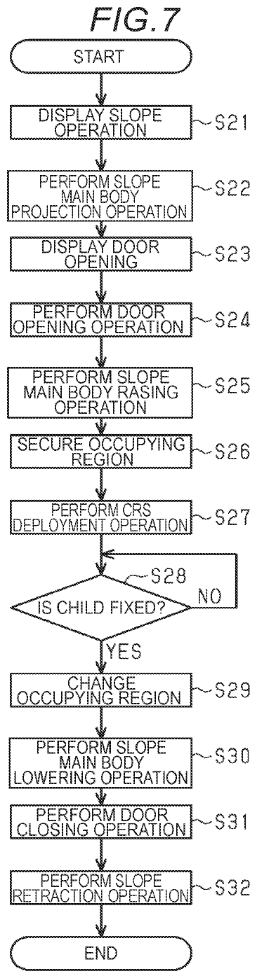

As illustrated in FIG. 7, when the processing proceeds to this routine, the front display drive circuit 38 and the rear display drive circuit 39 are driven and controlled in Step S21 such that the mark M1, which is to alert the user and the surroundings of the user to the projecting operation of the slope main body 8, is displayed on the front display 5 and the rear display 6. Then, in Step S22, the slope in/out drive unit 31 is driven and controlled such that the slope main body 8 projects. In addition, in Step S23, the front display drive circuit 38 and the rear display drive circuit 39 are driven and controlled such that the marks M2 and M3, which are to alert the user and the surroundings of the user to the opening operation of the front slide door 3 and the rear slide door 4, are respectively displayed on the front display 5 and the rear display 6.

Subsequently, in Step S24, the front door drive unit 33 and the rear door drive unit 34 are respectively driven and controlled such that the front slide door 3 and the rear slide door 4 are opened. In addition, in Step S25, the slope lifting drive unit 32 is driven and controlled such that the distal end 8b of the slope main body 8 is raised.

Subsequently, in Step S26, the front seat drive units 35R and 35L and the rear seat drive units 36R and 36L are driven and controlled such that the occupying region Z2 of the stroller O2 is secured on the floor 7. Then, in Step S27, the child restraint device 13 of the seat fixing a child is deployed.

Then, in Step S28, it is determined, based on the detection result of the seat belt switch 29 of the seat where the child restraint device 13 is deployed, whether or not the child in the stroller O2 that has moved on the slope 9 and moved to the floor 7 has been fixed. Here, after waiting for the child in the stroller O2 to be fixed, the front seat drive units 35R and 35L and the rear seat drive units 36R and 36L are driven and controlled such that the occupying region Z2 is changed in Step S29.

Then, in Step S30, the slope lifting drive unit 32 is driven and controlled such that the distal end 8b of the slope main body 8 is lowered. In addition, in Step S31, the front door drive unit 33 and the rear door drive unit 34 are respectively driven and controlled such that the front slide door 3 and the rear slide door 4 are closed. Further, in Step S32, the slope in/out drive unit 31 is driven and controlled such that the slope main body 8 is retracted. Then, the processing is ended.

The action and effect of the present embodiment will be described.

(1) In the present embodiment, the slope 9 is formed by the ECU 20 driving and controlling the slope in/out drive unit 31 and the slope lifting drive unit 32 and the occupying regions Z1 and Z2 of the wheelchair O1 or the stroller O2 are secured on the floor 7 by the ECU 20 driving and controlling the front seat drive units 35R and 35L and the rear seat drive units 36R and 36L. As a result, the wheelchair O1 or the stroller O2 that has moved on the slope 9 and moved to the floor 7 can be more smoothly disposed on the floor 7 using the occupying regions Z1 and Z2. The occupying regions Z1 and Z2 are secured in accordance with the formation of the slope 9 as described above, and thus it is possible to further reduce the troublesomeness in assisting the boarding of the wheelchair O1 or the stroller O2.

(2) In the present embodiment, the slope main body 8 is disposed so as to project from the slope entrance/exit 2b of the body 2 at a position below the floor 7 and, in a state where the slope main body 8 projects from the slope entrance/exit 2b, the slope main body 8 is raised such that the height of the distal end 8b on the body 2 side in the projecting and retracting direction of the slope main body 8 matches the height of the floor 7. As a result, the height of the distal end 8b of the slope main body 8 matches the height of the floor 7 in a state where the slope main body 8 projects from the slope entrance/exit 2b and forms the slope 9. Accordingly, it is possible to suppress step formation between the distal end 8b of the slope main body 8 and the floor 7 and the wheelchair O1 or the stroller O2 can be more smoothly moved onto the floor 7.

(3) In the present embodiment, the ECU 20 drives and controls the front seat drive units 35R and 35L and the rear seat drive units 36R and 36L such that the front-rear-direction separation distance between the front seats 11R and 11L and the rear seats 12R and 12L increases. As a result, the occupying regions Z1 and Z2 of the wheelchair O1 or the stroller O2 can be secured on the floor 7.

(4) In the present embodiment, the ECU 20 drives and controls the front seat drive units 35R and 35L and the rear seat drive units 36R and 36L when the holding state of the wheelchair O1 is detected. The occupying region Z1 is changed as a result. Accordingly, it is possible to suppress the occupying region Z1 being secured in vain for the wheelchair O1 that does not move on the floor 7 any longer. Alternatively, the occupying region Z2 is changed by the front seat drive units 35R and 35L and the rear seat drive units 36R and 36L being driven and controlled by the ECU 20 when the fixed state of a child is detected, that is, when the state of use of the child restraint device 13 is detected. Accordingly, it is possible to suppress the occupying region Z2 being secured in vain for the stroller O2 that does not move on the floor 7 any longer.

(5) In the present embodiment, the in-vehicle camera 23 detects the seat on which the companion P1 in the wheelchair O1 intends to sit, that is, the rear seat 12L. The occupying region Z1 is changed by the rear seat 12L moving in the front-rear direction so as to be next to the wheelchair O1. As a result, the companion P1 is seated on the rear seat 12L next to the wheelchair O1. Accordingly, the companion P1 is next to a person with walking difficulties sitting in the wheelchair O1, and thus the companion P1 can be more closely related to the person with walking difficulties by, for example, talking to or taking care of the person.

(6) In the present embodiment, the in-vehicle camera 23 detects the seats on which the companion P2 of the stroller O2 intends to sit, that is, the rear seats 12R and 12L. The occupying region Z2 is changed by moving in the front-rear direction together with the front seat 11L and the rear seats 12R and 12L such that the front-rear-direction separation distance between the seats using the child restraint device 13, that is, the front seat 11L and the rear seats 12R and 12L is reduced. As a result, the companion P2 is seated on the rear seats 12R and 12L with the front-rear-direction separation distance from the front seat 11L reduced. Accordingly, the companion P2 can be more closely related to a child by, for example, taking care of the child by being closer in the front-rear direction to the child fixed in the front seat 11L.

(7) In the present embodiment, a scheduled action of the vehicle 1 such as the projecting operation of the slope main body 8 and the opening operation of the front slide door 3 and the rear slide door 4 is displayed on the front display 5 and the rear display 6. As a result, it is possible to visually alert a person to the action.

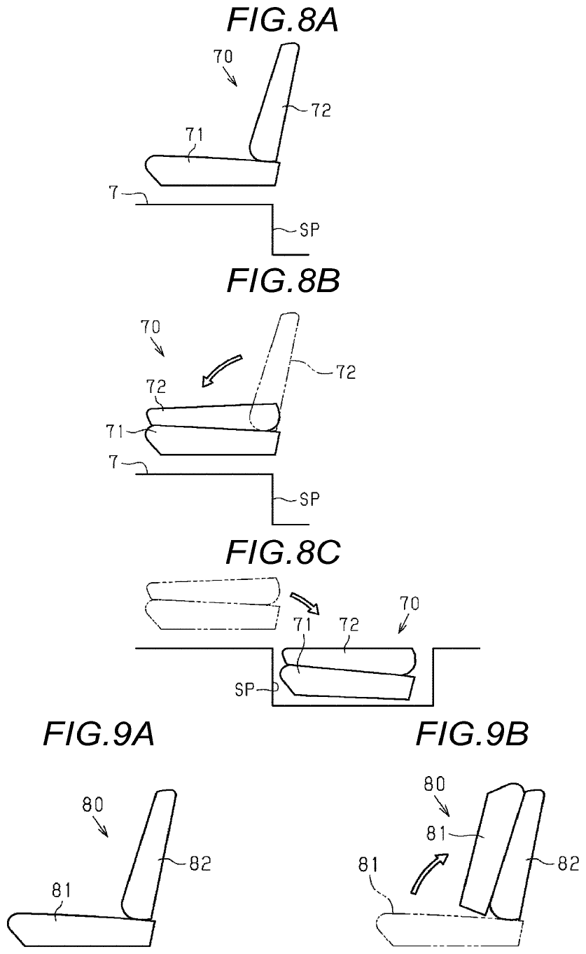

The present embodiment can be implemented with the following modifications. The present embodiment and the following modification examples can be implemented in combination with each other within a technically consistent scope.
As illustrated in FIG. 3, a gradient sensor 61 detecting the gradient of the slope 9 may be connected to the ECU 20 and an air suspension drive unit 62 increasing or decreasing the air in the air suspension with which the vehicle 1 is equipped may be connected to the ECU 20. The air suspension drive unit 62 may be driven and controlled for a decrease in vehicle height when the gradient detected by the gradient sensor 61 exceeds a certain value. In this case, the height of the distal end 8b of the slope main body 8 from the ground surface decreases, and thus the gradient falls within a certain value. As a result, the boarding of the wheelchair O1 can become smoother for manual and electric types alike. Alternatively, the boarding of the stroller O2 or luggage with a caster can become smoother.
As illustrated in FIGS. 8A to 8C, a seat 70 as one of the front seats 11R and 11L and the rear seats 12R and 12L may be provided with a seat cushion 71 constituting a seating portion and a seat back 72 constituting a backrest portion pivotally connected to the seat cushion 71 via a seat reclining mechanism (not illustrated). In addition, the seat 70 may be configured to be freely deployed and stored in an accommodation space SP formed in the floor 7 via a seat deployment/storage mechanism (not illustrated). The occupying region of a boarding assistance target may be secured on the floor 7 by the seat back 72 being folded on the seat cushion 71 and accommodated in the accommodation space SP.

As illustrated in FIG. 3, in this case, a reclining angle sensor 73 detecting the inclination angle of the seat back 72 with respect to the seat cushion 71 and a reclining drive unit 74 are connected to the ECU 20. The reclining drive unit 74 mainly includes an electric drive source such as an electric motor and drives the seat back 72 to tilt with respect to the seat cushion 71 by being mechanically linked to the seat reclining mechanism described above. In addition, a deployment/storage drive unit 75 is connected to the ECU 20. The deployment/storage drive unit 75 mainly includes an electric drive source such as an electric motor and drives the seat 70 to be deployed and stored in the accommodation space SP by being mechanically linked to the seat deployment/storage mechanism described above. Accordingly, the occupying region of a boarding assistance target can be secured on the floor 7 by the ECU 20 driving and controlling the reclining drive unit 74 and the deployment/storage drive unit 75 such that the seat back 72 is folded on the seat cushion 71 and accommodated in the accommodation space SP. The reclining drive unit 74 and the deployment/storage drive unit 75 constitute a seat drive source.
As illustrated in FIGS. 9A and 9B, a seat 80 as one of the front seats 11R and 11L and the rear seats 12R and 12L may be provided with a seat cushion 81 constituting a seating portion and a seat back 82 constituting a backrest portion pivotally connected to the seat cushion 81 via a seat reclining mechanism (not illustrated). The occupying region of a boarding assistance target may be secured on the floor 7 by the seat cushion 81 being erected along the seat back 82.

As illustrated in FIG. 3, in this case, a reclining angle sensor 83 detecting the inclination angle of the seat back 82 with respect to the seat cushion 81 and a reclining drive unit 84 as a seat drive source are connected to the ECU 20. The reclining drive unit 84 mainly includes an electric drive source such as an electric motor and drives the seat cushion 81 to tilt with respect to the seat back 82 by being mechanically linked to the seat reclining mechanism described above. Accordingly, the occupying region of a boarding assistance target can be secured on the floor 7 by the ECU 20 driving and controlling the reclining drive unit 84 such that the seat cushion 81 is erected along the seat back 82.
In the embodiment described above, the seats on which the companions P1 and P2 intend to sit may be detected based on, for example, the information of the information signal Im. Alternatively, in a case where an appropriate selection switch capable of selecting the seats on which the companions P1 and P2 intend to sit is provided, the detection may be performed based on the selection result of the selection switch.
In the embodiment described above, the occupying region Z2 secured on the floor 7 may be changed by only one of the front seat 11L and the rear seats 12R and 12L moving in the front-rear direction.
In the embodiment described above, the occupying regions Z1 and Z2 secured on the floor 7 may be changed by moving at least one of the front seats 11R and 11L and the rear seats 12R and 12L in the front-rear direction within a range in which interference with a boarding assistance target can be avoided.
In the embodiment described above, the occupying regions Z1 and Z2 secured on the floor 7 may not be changed.
In the embodiment described above, the projecting and retracting operation and the lifting operation of the slope main body 8 are performed by the drive control of the slope in/out drive unit 31 and the drive control of the slope lifting drive unit 32, respectively. In a case where the slope in/out drive mechanism related to the projecting and retracting operation of the slope main body 8 and the slope lifting drive mechanism related to the lifting operation are configured to be mechanically interlocked, the projecting and retracting operation and the lifting operation of the slope main body 8 may be performed only by the drive control of the slope in/out drive unit 31 with, for example, the slope lifting drive unit 32 omitted. In this case, the operation of the slope main body 8 can be realized with one motor, and thus the electrical configuration can be further simplified.
In the embodiment described above, the slope lifting drive unit 32 and the like may be omitted insofar as the slope main body 8 forms a slope by being bridged to the ground surface simply by projecting from the slope entrance/exit 2b. In other words, the slope main body 8 may perform no lifting operation.
In the embodiment described above, at least one of the front seats 11R and 11L and the rear seats 12R and 12L may be moved in the front-rear direction when the occupying regions Z1 and Z2 are secured on the floor 7. In this case, only one of the front seats 11R and 11L and the rear seats 12R and 12L may be allowed to move in the front-rear direction.
In the embodiment described above, the number of seats installed on the floor 7 may be changed to any number of two or more. In this case, at least one of the plurality of seats may be allowed to operate so as to secure an occupying region on the floor 7.
In the embodiment described above, the occupying regions Z1 and Z2 may be secured on the floor 7 in advance based on the input of the information signal Im during the input of the information signal Im. For example, in a case where the vehicle 1 is a self-driving car used as a taxi or a shared car, the occupying regions Z1 and Z2 may be secured when a so-called reservation information signal Im is input. As a result, the securing of the occupying regions Z1 and Z2 can be completed in the stage in which the regular user is present outside the vehicle 1 that is stationary at the latest.
In the embodiment described above, the voice from the speaker 16 may be used in combination during the alerting to the projecting operation of the slope main body 8 in Steps S1 and S21. In this case, it is possible to audibly perform the alerting to the action as well. Alternatively, in a case where the mobile phone 51 is configured to be capable of vibrating through the communication device 21, the vibration of the mobile phone 51 may be used in combination. In this case, the alerting to the action can be tactilely performed as well.
In the embodiment described above, the voice from the speaker 16 may be used in combination during the alerting to the opening operation of the front slide door 3 and the rear slide door 4 in Steps S3 and S23. In this case, it is possible to audibly perform the alerting to the action as well. Alternatively, in a case where the mobile phone 51 is configured to be capable of vibrating through the communication device 21, the vibration of the mobile phone 51 may be used in combination. In this case, the alerting to the action can be tactilely performed as well.
In the embodiment described above, the image recognition result of the video signal Vi may be used in combination during the determination of the holding state of the wheelchair O1 in Step S7.
In the embodiment described above, the deployment of the child restraint device 13 in Step S27 may be changed to any timing until the stroller O2 moves on the floor 7. For example, the child restraint device 13 may be deployed at a point in time when the presence of the stroller O2 outside the vehicle 1 is detected based on the information of the information signal Im or the image recognition result of the video signal Vo. For example, in a case where the vehicle 1 is a self-driving car used as a taxi or a shared car, the child restraint device 13 may be deployed when a so-called reservation information signal Im is input. As a result, the deployment of the child restraint device 13 can be completed in the stage in which the regular user is present outside the vehicle 1 that is stationary at the latest.
In the embodiment described above, the image recognition result of the video signal Vi may be used in combination during the determination of the fixed state of a child in Step S28. Alternatively, in a case where an appropriate seating sensor detecting the state of use of the seat is provided, the detection result of the seating sensor may be used in combination during the determination of the fixed state of a child in Step S28.
In the embodiment described above, the movement of the seat on which the companion P2 sits and the movement of the seat where the child is fixed are performed in that order during the change of the occupying region Z2 in Step S29. The movement of the seat on which the companion P2 sits and the movement of the seat where the child is fixed may be performed in the reverse order. Alternatively, the movement of the seat on which the companion P2 sits and the movement of the seat where the child is fixed may be performed at the same time.
In the embodiment described above, an appropriate mark or character for alerting the user or the surroundings of the user to the closing operation of the front slide door 3 and the rear slide door 4 may be displayed on each of the front display 5 and the rear display 6 prior to the lowering operation of the distal end 8b of the slope main body 8 in Steps S9 and S30. In this case, it is possible to visually perform the alerting to the action as well. At this time, the voice from the speaker 16 may be used in combination. In this case, it is possible to audibly perform the alerting to the action as well. Alternatively, in a case where the mobile phone 51 is configured to be capable of vibrating through the communication device 21, the vibration of the mobile phone 51 may be used in combination. In this case, the alerting to the action can be tactilely performed as well.
In the embodiment described above, the speaker drive circuit 40 may be driven and controlled such that a sound comfortable for the child is uttered from the speaker 16 when it is detected that the stroller O2 is present outside the vehicle 1.
In the embodiment described above, the projecting operation of the slope main body 8 may be stopped in a case where it is detected that the operation is hindered during the operation. The projecting operation of the slope main body 8 being hindered may be detected based on, for example, the image recognition result of the video signal Vo.
In the embodiment described above, a plurality of light emitting members may be disposed along, for example, the contour of the slope main body 8 so that the outer shape of the slope main body 8 in a projecting state is visible with ease.
In the embodiment described above, a plurality of light emitting members emitting light to a region on the ground surface that is scheduled to be occupied during the projection of the slope main body 8 may be provided prior to the projection of the slope main body 8.
In the embodiment described above, the operation of the slope main body 8 and the securing of the occupying region in conjunction with the operation may be performed in accordance with the wheelchair O1 or the stroller O2 even when luggage with a caster as a boarding assistance target moving on the slope 9 and moving to the floor 7 is present outside the vehicle 1.
In the embodiment described above, the entrance/exit of the boarding assistance target is formed by the opening 2a opened/closed by the pair of front slide door 3 and rear slide door 4. The entrance/exit of the boarding assistance target may be formed by an opening opened/closed by one slide door. Alternatively, the entrance/exit of the boarding assistance target may be formed by an opening disposed in the rear portion of the vehicle 1 and opened/closed by a back door.
In the embodiment described above, the control unit is not limited to the ECU 20 of the vehicle 1 and may be a server or the like provided outside the vehicle 1.
In the embodiment described above, the movement step may be to move an appropriate obstacle in the vehicle 1 such as a seat and a table so as to secure the occupying region of the boarding assistance target in the vehicle 1. Accordingly, the obstacle may not be supported on the floor 7 and may be supported by a pillar or the like in a state of, for example, floating from the floor 7. In addition, the obstacle may not move on the floor 7 and the direction of movement of the obstacle may include the vertical direction.

A vehicular boarding assistance device according to an aspect of this disclosure includes a slope main body provided in a body of a vehicle so as to project and retract and configured to form a slope by being bridged between the body and a ground surface in a state of projecting from the body, a slope drive source configured to drive the slope main body so as to project and retract, a seat drive source configured to drive at least one of a plurality of seats installed on a floor of the vehicle, and a control unit configured to drive and control the slope drive source such that the slope main body projects and drive and control the seat drive source such that an occupying region of a boarding assistance target moving on the slope and moving to the floor is secured on the floor.

According to the configuration described above, the slope is formed by the control unit driving and controlling the slope drive source and the occupying region of the boarding assistance target is secured on the floor by the control unit driving and controlling the seat drive source. As a result, the boarding assistance target that has moved on the slope and moved to the floor can be more smoothly disposed on the floor using the occupying region. The occupying region is secured in accordance with the formation of the slope as described above, and thus it is possible to further reduce the troublesomeness in assisting the boarding of the boarding assistance target.

The “occupying region” refers to a region including a disposition region that can be used for the boarding assistance target to be disposed and a movement region that can be used for a movement of the boarding assistance target for reaching the disposition region.

In the vehicular boarding assistance device, it is preferable that the slope main body is disposed so as to project from the body at a position below the floor and the slope main body is configured to rise such that a height of a distal end of the slope main body on the body side in a projecting and retracting direction matches a height of the floor in a state where the slope main body projects from the body.

According to the configuration described above, the height of the distal end of the slope main body matches the height of the floor in a state where the slope main body projects from the body and forms the slope. Accordingly, it is possible to suppress step formation between the distal end of the slope main body and the floor and the boarding assistance target can be more smoothly moved onto the floor.

In the vehicular boarding assistance device, it is preferable that the occupying region is secured on the floor by at least one of increasing a front-rear-direction separation distance between a front seat constituting the plurality of seats and a rear seat disposed behind the front seat and constituting the plurality of seats, folding a seat back on a seat cushion and accommodating the seat back and the seat cushion in an accommodation space formed in the floor in a case where the seat includes the seat cushion and the seat back pivotally connected to the seat cushion, and erecting a seat cushion along a seat back in a case where the seat includes the seat cushion and the seat back pivotally connected to the seat cushion.

According to the configuration described above, the control unit drives and controls the seat drive source such that the front-rear-direction separation distance between the front seat and the rear seat increases. As a result, the occupying region of the boarding assistance target can be secured on the floor. Alternatively, the occupying region of the boarding assistance target can be secured on the floor by the control unit driving and controlling the seat drive source such that the seat back is folded on the seat cushion and accommodated in the accommodation space. Alternatively, the occupying region of the boarding assistance target can be secured on the floor by the control unit driving and controlling the seat drive source such that the seat cushion is erected along the seat back.

In the vehicular boarding assistance device, it is preferable that the control unit drives and controls the seat drive source so as to change the secured occupying region either when a holding state of a wheelchair is detected in a case where the boarding assistance target is the wheelchair or when a state of use of a child restraint device is detected in a case where the boarding assistance target is a stroller.

According to the configuration described above, the control unit drives and controls the seat drive source when the holding state of the wheelchair is detected. The secured occupying region is changed as a result. Accordingly, it is possible to suppress the occupying region being secured in vain for the wheelchair that does not move on the floor any longer. Alternatively, the secured occupying region is changed by the seat drive source being driven and controlled by the control unit when the state of use of the child restraint device is detected. Accordingly, it is possible to suppress the occupying region being secured in vain for the stroller that does not move on the floor any longer.

It is preferable that the vehicular boarding assistance device further includes a detection section configured to detect a seat on which a companion of the wheelchair intends to sit in a case where the boarding assistance target is the wheelchair, and the secured occupying region is changed by moving the detected seat in a front-rear direction so as to be positioned side-by-side with the wheelchair.

According to the configuration described above, the companion is seated on the seat next to the wheelchair. Accordingly, the companion is next to a person with walking difficulties sitting in the wheelchair, and thus the companion can be more closely related to the person with walking difficulties.

It is preferable that the vehicular boarding assistance device further includes a detection section configured to detect a seat on which a companion of the stroller intends to sit in a case where the boarding assistance target is the stroller, and the secured occupying region is changed by moving at least one of a child fixing seat in which the child restraint device is used and a companion seat which is the detected seat in a front-rear direction such that a front-rear-direction separation distance between the child fixing seat and the companion seat is reduced.

According to the configuration described above, the companion is seated on the companion seat with the front-rear-direction separation distance from the child fixing seat reduced. Accordingly, the companion can be more closely related to a child by being closer in the front-rear direction to the child fixed in the child fixing seat.

A control unit for a vehicular boarding assistance device according to another aspect of this disclosure is a control unit for a vehicular boarding assistance device for controlling a slope drive source configured to drive a slope main body to project and retract, the slope main body being provided in a body of a vehicle so as to project and retract and forming a slope by being bridged between the body and a ground surface in a state of projecting from the body, and a seat drive source configured to drive at least one of a plurality of seats installed on a floor of the vehicle. The control unit drives and controls the slope drive source such that the slope main body projects and drives and controls the seat drive source such that an occupying region of a boarding assistance target moving on the slope and moving to the floor is secured on the floor.

According to the configuration described above, the slope is formed by the control unit driving and controlling the slope drive source and the occupying region of the boarding assistance target is secured on the floor by the control unit driving and controlling the seat drive source. As a result, the boarding assistance target that has moved on the slope and moved to the floor can be more smoothly disposed on the floor using the occupying region. The occupying region is secured in accordance with the formation of the slope as described above, and thus it is possible to further reduce the troublesomeness in assisting the boarding of the boarding assistance target.

A vehicle boarding assistance method according to another aspect of this disclosure includes a determination step of determining the presence or absence of a boarding assistance target, a boarding assistance step of causing a slope main body to project from a vehicle in a case where it is determined that the boarding assistance target is present in the determination step, and a movement step of moving within the vehicle an obstacle disposed in the vehicle so as to secure an occupying region of the boarding assistance target in the vehicle in a case where it is determined that the boarding assistance target is present in the determination step.

According to the configuration described above, in a case where it is determined that the boarding assistance target is present in the determination step, the slope main body projects from the vehicle and the slope is formed in the boarding assistance step and the obstacle moves and the occupying region of the boarding assistance target is secured in the vehicle in the movement step. As a result, the boarding assistance target that has moved on the slope and moved to the floor can be more smoothly disposed in the vehicle using the occupying region. The occupying region is secured in accordance with the formation of the slope as described above, and thus it is possible to further reduce the troublesomeness in assisting the boarding of the boarding assistance target.

This disclosure has an effect of being capable of further reducing the troublesomeness in assisting the boarding of the boarding assistance target.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicular boarding assistance device comprising:
a slope main body provided in a body of a vehicle so as to project and retract and configured to form a slope by being bridged between the body and a ground surface in a state of projecting from the body;
a slope drive source configured to drive the slope main body so as to project and retract;
a seat drive source configured to drive at least one of a plurality of seats installed on a floor of the vehicle; and
a control unit configured to drive and control the slope drive source such that the slope main body projects and drive and control the seat drive source such that an occupying region of a boarding assistance target moving on the slope and moving to the floor is secured on the floor.

2. The vehicular boarding assistance device according to claim 1, wherein
the slope main body is disposed so as to project from the body at a position below the floor and the slope main body is configured to rise such that a height of a distal end of the slope main body on the body side in a projecting and retracting direction matches a height of the floor in a state where the slope main body projects from the body.

3. The vehicular boarding assistance device according to claim 1, wherein
the occupying region is secured on the floor by at least one of:
increasing a front-rear-direction separation distance between a front seat constituting the plurality of seats and a rear seat disposed behind the front seat and constituting the plurality of seats,
folding a seat back on a seat cushion and accommodating the seat back and the seat cushion in an accommodation space formed in the floor in a case where the seat includes the seat cushion and the seat back pivotally connected to the seat cushion, and
erecting a seat cushion along a seat back in a case where the seat includes the seat cushion and the seat back pivotally connected to the seat cushion.

4. The vehicular boarding assistance device according to claim 1, wherein
the control unit drives and controls the seat drive source so as to change the secured occupying region either
when a holding state of a wheelchair is detected in a case where the boarding assistance target is the wheelchair or
when a state of use of a child restraint device is detected in a case where the boarding assistance target is a stroller.

5. The vehicular boarding assistance device according to claim 4, further comprising
a detection section configured to detect a seat on which a companion of the wheelchair intends to sit in a case where the boarding assistance target is the wheelchair, wherein
the secured occupying region is changed by moving the detected seat in a front-rear direction so as to be positioned side-by-side with the wheelchair.

6. The vehicular boarding assistance device according to claim 4, further comprising
a detection section configured to detect a seat on which a companion of the stroller intends to sit in a case where the boarding assistance target is the stroller, wherein
the secured occupying region is changed by moving at least one of a child fixing seat in which the child restraint device is used and a companion seat which is the detected seat in a front-rear direction such that a front-rear-direction separation distance between the child fixing seat and the companion seat is reduced.

7. A control unit for a vehicular boarding assistance device for controlling a slope drive source configured to drive a slope main body to project and retract, the slope main body being provided in a body of a vehicle so as to project and retract and forming a slope by being bridged between the body and a ground surface in a state of projecting from the body, and a seat drive source configured to drive at least one of a plurality of seats installed on a floor of the vehicle, wherein
the control unit drives and controls the slope drive source such that the slope main body projects and drives and controls the seat drive source such that an occupying region of a boarding assistance target moving on the slope and moving to the floor is secured on the floor.

8. A vehicle boarding assistance method comprising:
a determination step of determining the presence or absence of a boarding assistance target;
a boarding assistance step of causing a slope main body to project from a vehicle in a case where it is determined that the boarding assistance target is present in the determination step; and
a movement step of moving within the vehicle an obstacle disposed in the vehicle so as to secure an occupying region of the boarding assistance target in the vehicle in a case where it is determined that the boarding assistance target is present in the determination step.
